(19) United States
(12) Patent Application Publication
(10) Pub. No.: US 2003/0202770 A1
(43) Pub. Date: Oct. 30, 2003

(54) Optical waveguide amplifiers

(76) Inventors: Anthony F. Garito, Radnor, PA (US); Renyuan Gao, Wayne, PA (US); Yu-Ling Hsiao, Collegeville, PA (US); Brian Thomas, Exton, PA (US); Jingsong Zhu, Phoenixville, PA (US); Kazuya Takayama, Phoenixville, PA (US)

Correspondence Address: Finnegan, Henderson, Farabow,, Garrett & Dunner, L.L.P., 1300 I Street, N.W., Washington, DC, 20005-3315, US

(21) Appl. No.: 10/335,989

(22) Filed: Jan. 3, 2003

Related U.S. Application Data
(60) Provisional application No. 60/345,633, filed on Jan. 3, 2002.

(51) Int. Cl. G02B 6/00

(52) U.S. Cl. 385/141

(57) ABSTRACT

The present invention relates to optical waveguide devices and optical waveguide amplifiers for amplification in a range from 1.27 μm to about 1.6 μm wavelength, advantageously for about 1.3 μm wavelength amplification. The present invention also relates to planar optical waveguides, fiber waveguides, and communications systems employing them. The optical waveguide devices according to the present invention comprise a host matrix including polymers, solvents, crystals, and liquid crystals. Within the host matrix, a plurality of nanoparticles can be mixed to form a nanocomposite. The host matrix itself may comprise composite materials, such as polymer nanocomposites.

### CROSS-REFERENCE TO RELATED APPLICATION

This application claims the benefit of priory under 35 U.S.C. § 119(e) to U.S. Provisional Application No. 60/345,633 filed Jan. 3, 2002.

### FIELD OF THE INVENTION

The present invention relates to optical waveguide devices, particularly to optical waveguide devices comprising composite materials, such as polymer nanocomposites. The polymer nanocomposites according to the present invention comprise a host matrix and a plurality of nanoparticles within the host matrix. The present invention also relates to optical waveguide amplifiers ranging from about 1.27 μm to about 1.6 μm wavelength amplification.

### BACKGROUND

The advent of optical amplifiers and dense wavelength division multiplexing has revolutionized the telecommunications industry by replacing electronic data regenerators between optical fiber transmission links with less expensive, data format “transparent”, optical amplification devices. For example, silica based erbium-doped fiber amplifiers (EDFA), operating in the range from about 1.5 μm to about 1.6 μm wavelength window, are highly efficient and cost-effective. These erbium-doped fiber amplifiers have been the predominant optical amplification devices in long haul, ultra-long haul, and transoceanic networks.

Because of the tremendous success of the EDFA's, most of the long haul, ultra-long haul, and transoceanic networks use signal wavelength channels operating in the erbium amplification window ranging from about 1.5 μm to about 1.6 μm. Nevertheless, there is a significant amount of installed optical networks, such as cable television distribution systems, operating at the second-loss window of silica optical fibers around 1.3 μm.

Additionally, because of the presence of cost-effective components, the newly emerging metropolitan optical networks and optical Ethernet networks are increasingly being operated around 1.3 μm. Examples of these cost-effective components include vertical cavity surface emission lasers, 1.3 μm transponders, and 1.3 μm transceivers. Because of the continuing need for efficient, cost-effective solutions for telecommunications, as well as the need for improving existing 1.3 μm optical systems, it is of great importance to have an efficient, cost-effective 1.3 μm optical amplification device.

Several different types of technologies have been attempted and evaluated in the past several years, including semiconductor optical amplifiers, Raman fiber amplifiers, and fiber amplifiers doped with Praseodymium (Pr), Dysprosium (Dy), and Neodymium (Nd). Because of various performance and manufacturing problems, such as low efficiency, high noise, poor reliability, etc, none of the above mentioned technologies have been widely used in optical networks.

Among the various approaches for 1.3 μm amplification, Pr and Dy doped fiber amplifiers have received the most attention. Pr or Dy doped amplifiers have been the most promising because of their higher efficiency. Most of the reported prior art 1.3 μm Pr or Dy doped amplifiers, however, employ fluoride, halide, chalcogenide, chalcohalide, selenide, and arsenic glasses.

These glasses are fabricated into optical fiber performs, and drawn into amplification optical fibers. Alternatively, planar waveguides can be formed using a doped fluoride glass substrate. In either case, the prior art technology relies on fluoride, halide, chalcogenide, chalcohalide, selenide, and arsenic glasses. These glasses are extremely mechanically fragile and sometimes moisture sensitive, thus making device reliability a severe issue. Another problem with glasses is that they are only low levels of dopant are possible, thus, requiring longer lengths of fiber to obtain a sufficient level of gain.

Impurities in the glass materials, as well as the presence of hydrogen and oxygen, result in absorption losses. Additionally, there are attenuation maxima associated with small-band wavelength regions. These fundamental attenuated wavelength regions of highest absorption correspond to the presence of ions like (OH⁻). For example, it is well known that quartz has one such region of highest absorption at 2.7 μm. Other similar absorption bans occur at 1.38 μm, 1.24 μm, 0.95 μm, and 0.72 μm.

Between these wavelength bands of absorption there are “windows” of minimal attenuation. It is commonly known in the art that the first window occurs at 0.85 μm, the second at 1.3 μm, and the third at 1.5 μm. Since these regions are used for data transmission and communication technology, host matrix materials tending to degrade and reduce the strength of light signals passed through the composite materials are problematic.

Likewise, hydrocarbon polymers commonly exhibit high absorption losses that can degrade their optical properties. These absorptions also originate from overtones of fundamental molecular vibrations within the hydrocarbon polymers. Many of these absorptions overtones fall within the range of wavelengths prevalent in telecommunications applications. For example, the highly absorptive overtones associated with C—H bonds of the hydrocarbon polymers fall within the range of wavelengths used in telecommunications applications. These absorptive overtones cause the matrix materials, such as hydrocarbon polymers, to degrade and reduce the strength of light signals passed through composite materials containing such matrix materials.

Devices based on discrete fiber components such as Pr, Dy, or Nd doped fluoride fibers are difficult, time consuming, and costly to fabricate into amplifier device modules. The complexities arise from the numerous splices required for connecting various components in the module, such as, for example, the pump/signal coupler, and tap coupler.

It is well known by those skilled in the art that planar waveguides provide a platform for achieving optical component integration. Planar waveguide based optical amplifiers have been developed in silica based glass containing rare-earth elements, primarily for 1.55 μm wavelength amplification. The optical gain medium can be formed by various processes, such as, for example, chemical vapor deposition, ion exchange, photo-lithography, flame-hydrolysis, and reactive ion-etching. The resulting gain medium can take the form of a straight line or curved rare-earth doped waveguide. Pump lasers with various wavelengths pump such rare-earth doped waveguide. The pump lasers are combined with the signal, for example from about 1.5 μm (advantageously 1.535 μm) to about 1.6 μm (advantageously 1.610 μm) for erbium-doped channel waveguide, by a directional coupler. Optical isolators are inserted into the optical path to prevent back-reflected signal amplification in the rare-earth doped channel waveguides.

An optical amplifier amplifies optical signal directly in the optical domain without converting the signal into an electrical signal. The key to an optical signal amplifier device is the gain medium. A gain medium can be made by doping rare-earth ions into the core of an optical fiber. However, rare earth doped optical fiber has the disadvantage of high-cost, long length, and difficulty of integration with other optical components, such as optical couplers, splitters, detectors, and diode lasers, resulting in high cost of manufacturing and bulkiness of the devices. It would be beneficial to have an integrated solution for optical amplification.

The use of rare-earth doped glass waveguides is well known in the art. In order to form glass channel waveguides, however, it is necessary to form glass films for the under-cladding, core, and over-cladding layers. Typical fabrication processes of glass films include, chemical vapor deposition, plasma enhanced chemical vapor deposition, and flame hydrolysis. These fabrication processes require complex equipment, are time consuming, and costly. Moreover, these processes have been developed only for silica-based glass, which is only compatible with erbium amplifiers operating in the 1.55 μm wavelength window.

Composite materials are well known, and generally comprise two or more materials each offering its own set of properties or characteristics. The two or more materials may be joined together to form a system that exhibits properties derived from each of the materials. A common form of a composite is one with a body of a first material (a matrix) with a second material distributed in the matrix.

One class of composite materials includes nanoparticles distributed within a host matrix material. Nanoparticles are particles of a given material that have a size measured on a nanometer scale. Generally, nanoparticles are larger than a cluster (which might be only a few hundred atoms in some cases), but with a relatively large surface area-to-bulk volume ratio. While most nanoparticles have a size from about 10 nm to about 500 nm, the term nanoparticles can cover particles having sizes that fall outside of this range. For example, particles having a size as small as about 1 nm and as large as about 1×10³ nm could still be considered nanoparticles. Nanoparticles can be made from a wide array of materials. Among these materials examples include, transition metals, rare-earth metals, group VA elements, polymers, dyes, semiconductors, alkaline earth metals, alkali metals, group IIIA elements, and group IVA elements.

Further, nanoparticles themselves may be considered a nanoparticle matrix, which may comprise a wide array of materials, single elements, mixtures of elements, stoichiometric or non-stoichiometric compounds. The materials may be crystalline, amorphous, or mixtures, or combinations of such structures.

Composite materials including nanoparticles distributed within a host matrix material have been used in optical applications. For example, U.S. Pat. No. 5,777,433 (the '433 patent) discloses a light emitting diode (LED) that includes a packaging material including a plurality of nanoparticles distributed within a host matrix material. The nanoparticles increase the index of refraction of the host matrix material to create a packaging material that is more compatible with the relatively high refractive index of the LED chip disposed within the packaging material. Because the nanoparticles do not interact with light passing through the packaging material, the packaging material remains substantially transparent to the light emitted from the LED.

While the packaging material used in the '433 patent offers some advantages derived from the nanoparticles distributed within the host matrix material, the composite material of the '433 patent remains problematic. For example, the composite material of the '433 patent includes glass or ordinary hydrocarbon polymers, such as epoxy and plastics, as the host matrix material. While these materials may be suitable in certain applications, they limit the capabilities of the composite material in many other areas. For example, the host matrix materials of the '433 patent commonly exhibit high absorption losses.

Additionally, the method of the '433 patent for dealing with agglomeration of the nanoparticles within the host matrix material is inadequate for many composite material systems. Agglomeration is a significant problem when making composite materials that include nanoparticles distributed within a host matrix material. Because of the small size and great numbers of nanoparticles that may be distributed within a host matrix material, there is a large amount of interfacial surface area between the surfaces of the nanoparticles and the surrounding host matrix material. As a result, the nanoparticle/host-matrix material system attempts to minimize this interfacial surface area, and corresponding surface energy, by combining the nanoparticles together to form larger particles. This process is known as agglomeration. Once the nanoparticles have agglomerated within a host matrix material, it is extremely difficult to separate the agglomerated particles back into individual nanoparticles.

Agglomeration of the nanoparticles within the host matrix material may result in a composite material that lacks a desired characteristic. Specifically, when nanoparticles agglomerate together, the larger particles formed may not behave in a similar way to the smaller nanoparticles. For example, while nanoparticles may be small enough to avoid scattering light within the composite material, agglomerated particles may be sufficiently large to cause scattering. As a result, a host matrix material may become substantially less transparent in the presence of such agglomerated particles.

To combat agglomeration, the composite material of the '433 patent includes an anti-flocculant coating disposed on the nanoparticles intended to inhibit agglomeration. Specifically, the '433 patent suggests using surfactant organic coatings to suppress agglomeration. These types of coatings, however, may be inadequate or ineffective especially when used with host matrix materials other than typical hydrocarbon polymers.

As a result, there is a need in the art for an easy to manufacture, integrated 1.3 μm optical amplifiers, as well as optical amplifiers that overcome one or more of the above-described problems or disadvantages of the prior art. It is also desirable to have a waveguide amplifier material system, and fabrication process, that is versatile, reliable, and cost-effective. Additionally, modern telecommunication networks increasingly need compact, low cost, and integrated optical signal regeneration and amplification devices.

### SUMMARY OF THE INVENTION

The present invention relates to optical waveguide devices and optical waveguide amplifiers for amplification in a range from 1.27 μm to about 1.6 μm wavelength, advantageously for about 1.3 μm wavelength amplification. The present invention also relates to planar optical waveguides, fiber waveguides, and communications systems employing them. The optical waveguide devices according to the present invention comprise a host matrix including polymers, solvents, crystals, and liquid crystals. Within the host matrix, a plurality of nanoparticles can be mixed to form a nanocomposite. In fact, the host matrix itself may comprise composite materials, such as polymer nanocomposites.

The nanocomposites according to the present invention comprise a host matrix and a plurality of nanoparticles within the host matrix.

In one embodiment of the present invention, the optical planar waveguide operating in the 1.3 μm wavelength window comprises a nanoparticle polymer composite.

In another embodiment of the present invention, there is a process of forming an optical waveguide comprising a composite material, which includes a host matrix and a plurality of nanoparticles within the host matrix. In such embodiments, the plurality of nanoparticles may comprise at least one Dysprosium Praseodymium, and Neodymium containing material.

In yet another exemplary embodiment according to the present invention, there is an optical waveguide amplifier comprising a composite material, which includes a halogen containing host matrix, and a plurality of nanoparticles within the host matrix. In such embodiments, the plurality of nanoparticles comprises at least one dopant material that provides amplification at approximately 1.3 μm.

An example of an optical amplifying waveguide according to the present invention includes a core comprising a composite material which includes a host matrix and a plurality of nanoparticles dispersed within the host matrix. A majority of the plurality of nanoparticles may be bare or include a halogenated outer coating layer. Advantageously, the nanoparticles comprise at least one dopant material chosen from Dysprosium, Praseodymium, and Neodymium. In certain embodiments, the optical amplifying waveguide may include a core-cladding comprised of a lower refractive index material, such that a core-cladding refractive index difference is small enough to result in a single optical mode propagation for optical wavelengths ranging from 1.27 μm to about 1.6 μm.

Another example of the present invention is an apparatus for optical communication including: an active material comprising, a halogen containing host matrix, and a plurality of nanoparticles within the host matrix. The plurality of nanoparticles may comprise at least one material chosen from Dysprosium, Praseodymium, and Neodymium. Such an apparatus generates an optical signal and an optical pumping, provides the optical signal and the optical pumping to the waveguide; and controls light emitted from the optical waveguide.

A further example includes an optical amplifier for wavelength ranging from about 1.27 μm to about 1.6 μm. The amplifier again may comprise a nanoparticle composite material comprising a host matrix and a plurality of nanoparticles dispersed within the host matrix. A majority of nanoparticles which include at least one material chosen from Dysprosium, Praseodymium, and Neodymium; may be bare or contain a halogenated outer coating layer.

The present invention also encompasses a method for amplifying a light signal. For example a method for amplifying a light signal can include forming a component from a composite material comprising a halogen containing host matrix, and a plurality of nanoparticles within the host matrix. The nanoparticles suitably comprise at least one material chosen from Dysprosium, Praseodymium, and Neodymium. The method next involves exciting ions of the at least one material into their excited energy state. The pump photons enter the doped fiber or waveguide core (doped with at least one material chosen from Dy, Pr, and Nd), and are absorbed by the ground state Dy, Pr, or Nd ions. The absorption of the pump photons causes the excitation of the ions into their excited energy state. The excited state ions rapidly (in less than about 1 μsec) relax to the metastable excited state. The metastable excited state has a relatively long lifetime when not triggered (greater than about 5 μsec). When triggered by a signal photon with wavelength around 1.31 μm, a metastable state ion drops back to its ground state and releases a emission photon identical to the triggering signal photon, thereby amplifying the signal.

Another method according to the present invention includes amplifying a light signal. This method comprises forming a component from a composite material, which includes a halogen containing host matrix, and a plurality of nanoparticles within the halogen containing host matrix. The nanoparticles according to this method comprise at least one material capable of producing stimulated emissions of light within a wavelength ranging from about 1.27 μm to about 1.34 μm.

In yet another embodiment of the present invention, there is an optical waveguide comprising a core for transmitting incident light, and a cladding material disposed about the core. The core of the optical waveguide may comprise a host matrix, and a plurality of nanoparticles dispersed within the host matrix, where the plurality of nanoparticles includes a halogenated outer coating layer.

A general description of methods for fabricating polymer optical waveguides and polymer optical waveguide amplifiers based on polymer film formation and subsequent channel formation processes can be found in related co-pending application Ser. No. 10/243,833, the contents of which are herein incorporated by reference.

In one embodiment, the inventive amplifier comprises perfluorinated polymer waveguide host matrix materials. In such and embodiment, the perfluorinated polymer waveguide core may comprise nanometer size particles of various glasses, polymers, and crystal materials. The nanometer size particles are doped with at least one material chosen from Pr, Dy, and Nd for 1.3 μm amplification. The nanoparticles are evenly and randomly distributed within the waveguide core and do not significantly change the processing conditions of the waveguide formation. Furthermore, as the host matrix polymer material serves as a hermetic seal and mechanical support for the nanoparticles, there is a large group of nanoparticles that can be used with the host matrix core material without the concern of processability, reliability, and environmental stability. For example, some crystal materials doped with at least one material chosen from Pr, Dy, and Nd can be utilized to form nano-composite polymer optical waveguides that are not previously possible in their pure and bulk form.

### BRIEF DESCRIPTION OF THE DRAWINGS

In the drawings:

FIG. 1 depicts a schematic representation of an exemplary composite material according to one embodiment of the invention.

FIG. 2 depicts a schematic cross-sectional view of a waveguide according to another embodiment of the present invention.

FIG. 3 depicts a schematic representation of a curved waveguide according to another exemplary embodiment of the present invention.

FIG. 4 depicts a schematic representation of waveguides showing one embodiment according to the present invention.

FIG. 5 depicts a schematic representation of another waveguide embodiment of the present invention.

FIG. 6 depicts schematic representation of a composite material comprising nanoparticles according to another embodiment of the present invention.

FIG. 7 depicts a schematic representation of nanoparticles according to another embodiment of the present invention.

FIG. 8 depicts a flowchart representing a process for forming a composite material according to one embodiment of the present invention.

FIG. 9 depicts the energy level diagrams for Pr³⁺ and Dy³⁺.

FIG. 10 depicts an optical amplifier in a communication/transmission system according to one embodiment of the present invention.

### DETAILED DESCRIPTION OF THE INVENTION

In the following description, reference is made to the accompanying drawings that form a part thereof, and in which is shown by way of illustration specific exemplary embodiments in which the invention can be practiced. These embodiments are described in sufficient detail to enable those skilled in the art to practice the invention, and it is to be understood that other embodiments can be utilized and that changes can be made without departing from the scope of the present invention.

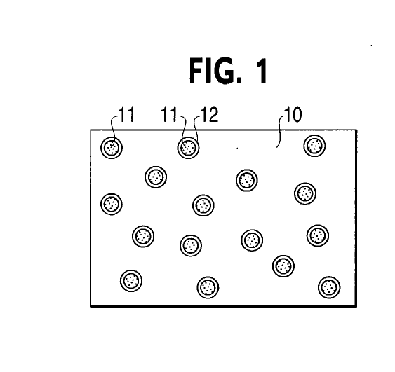

FIG. 1 provides a diagrammatic representation of a composite material according to an embodiment of the invention. In one embodiment, the nano-composite waveguide core comprises the composite material. The composite material includes host matrix 10 and plurality of nanoparticles 11 dispersed either uniformly or non-uniformly within the host matrix 10. The plurality of nanoparticles 11 may include halogenated outer coating layer 12, which at least partially coats nanoparticles 11 and discourages their agglomeration. The nanoparticles 11 according to the present invention may be doped with at least one material chosen from Pr, Dy, and Nd. The nanoparticles of doped glassy media, single crystal, or polymer are embedded in the host matrix core material 10. The distributions of the active nanoparticles are random and homogenous. In cases where there is interface delamination due to mismatches of mechanical, chemical, or thermal properties between the nanoparticles and the surrounding polymer core host matrix, a compliance layer may be coated on the nanoparticles to enhance the interface properties between the nanoparticles and the host matrix polymer core material.

As shown in FIG. 1, the nanoparticles may include an outer layer 12. As used herein, the term layer is a relatively thin coating on the outer surface of an inner core (or another inner layer) that is sufficient to impart different characteristics to the outer surface. The layer need not be continuous or thick to be an effective layer, although it may be both continuous and thick in certain embodiments.

The host matrix 10 can comprise a halogenated elastomer, a perhalogenated elastomer, a halogenated plastic, or a perhalogenated plastic, either by itself or in a blend with other matrix material listed herein.

In another embodiment, the host matrix 10 may comprise a polymer, a copolymer, or a terpolymer having at least one halogenated monomer represented by one of the following formulas:

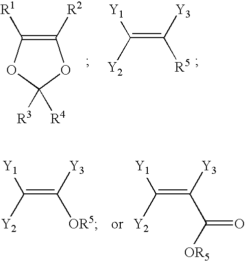

wherein R¹, R², R³, R⁴, and R⁵, which may be identical or different, are each chosen from linear or branched hydrocarbon-based chains, possibly forming at least one carbon-based ring, being saturated or unsaturated, wherein at least one hydrogen atom of the hydrocarbon-based chains may be halogenated; a halogenated alkyl, a halogenated aryl, a halogenated cyclic alky, a halogenated alkenyl, a halogenated alkylene ether, a halogenated siloxane, a halogenated ether, a halogenated polyether, a halogenated thioether, a halogenated silylene, and a halogenated silazane. Y₁ and Y₂, which may be identical or different, are each chosen from H, F, Cl, and Br atoms. Y₃ is chosen from H, F, Cl, and Br atoms, CF₃, and CH₃.

Alternatively, the polymer may comprise a condensation product made from the monomers listed below:

HO—R—OH+NCO—R′—NCO; or

HO—R—OH+Ary¹-Ary²,

wherein R, R′, which may be identical or different, are each chosen from halogenated alkylene, halogenated siloxane, halogenated ether, halogenated silylene, halogenated arylene, halogenated polyether, and halogenated cyclic alkylene. Ary¹, Ary², which may be identical or different, are each chosen from halogenated aryls and halogenated alkyl aryls.

Ary as used herein, is defined as being a saturated, or unsaturated, halogenated aryl, or a halogenated alkyl aryl group.

Alternatively, the host matrix 10 can comprise a halogenated cyclic olefin polymer, a halogenated cyclic olefin copolymer, a halogenated polycyclic polymer, a halogenated polyimide, a halogenated polyether ether ketone, a halogenated epoxy resin, a halogenated polysulfone, or halogenated polycarbonate.

The host matrix 10, for example, the fluorinated polymer host matrix 10, may exhibit very little absorption loss over a wide wavelength range. Therefore, such fluorinated polymer materials may be suitable for optical applications.

In one embodiment, the halogenated aryl, alkyl, alkylene, alkylene ether, alkoxy, siloxane, ether, polyether, thioether, silylene, and silazane groups are at least partially halogenated, meaning that at least one hydrogen in the group has been replaced by a halogen. In another embodiment, at least on hydrogen in the group may be replaced by fluorine. Alternatively, these aryl, alkyl, alkylene, alkylene ether, alkoxy, siloxane, ether, polyether, thioether, silylene, and silazane groups may be completely halogenated, meaning that each hydrogen of the group has been replaced by a halogen. In an exemplary embodiment, the aryl, alkyl, alkylene, alkylene ether, alkoxy, siloxane, ether, polyether, thioether, silylene, and silazane groups may be completely fluorinated, meaning that each hydrogen has been replaced by fluorine. Furthermore, the alkyl and alkylene groups may include between 1 and 12 carbon atoms.

Additionally, host matrix 10 may comprise a combination of one or more different halogenated polymers, such as fluoropolymers, blended together. Further, host matrix 10 may also include other polymers, such as halogenated polymers containing functional groups such as phosphinates, phosphates, carboxylates, silanes, siloxanes, sulfides, including POOH, POSH, PSSH, OH, SO₃H, SO₃R, SO₄R, COOH, NH₂, NHR, NR₂, CONH₂, NH—NH₂, and others, where R may comprise any of aryl, alkyl, alkylene, siloxane, silane, ether, polyether, thioether, silylene, and silazane. Further, host matrix 10 may also include homopolymers or copolymers of vinyl, acrylate, methacrylate, vinyl aromatic, vinyl esters, alpha beta unsaturated acid esters, unsaturated carboxylic acid esters, vinyl chloride, vinylidene chloride, and diene monomers. Further, the host matrix may also include a hydrogen-containing fluoroelastomer, a hydrogen-containing perfluoroelastomer, a hydrogen containing fluoroplastic, a perfluorothermoplastic, at least two different fluoropolymers, or a cross-linked halogenated polymer.

Examples of the host matrix 10 include: poly[2,2-bistrifluoromethyl-4,5-difluoro -1,3-dioxole-co-tetrafluoroethylene], poly[2,2-bisperfluoroalkyl-4,5-difluoro-1,3-dioxole-co-tetrafluoroethylene], poly[2,3-(perfluoroalkenyl) perfluorotetrahydrofuran], poly[2,2,4-trifluoro-5-trifluoromethoxy-1,3-dioxole-co-tetrafluoroethylene], poly(pentafluorostyrene), fluorinated polyimide, fluorinated polymethylmethacrylate, polyfluoroacrylates, polyfluorostyrene, fluorinated polycarbonates, fluorinated poly (N-vinylcarbazole), fluorinated acrylonitrile-styrene copolymer, fluorinated Nafion®), and fluorinated poly(phenylenevinylene). The host matrix 10 may further include inactive fillers, for example silica.

Additionally, the host matrix may comprise any polymer sufficiently clear for optical applications. Examples of such polymers include polymethylmethacrylates, polystyrenes, polycarbonates, polyimides, epoxys, cyclic olefin copolymers, cyclic olefin polymers, acrylate polymers, PET, polyphenylene vinylene, polyether ether ketone, poly (N-vinylcarbazole), acrylonitrile-styrene copolymer, Nafionn®, poly(phenylenevinylene), polyfluoroacrylates, fluorinated polycarbonates, perfluoro-polycyclic polymers, fluorinated cyclic olefins, or fluorinated copolymers of cyclic olefins.

By including halogens, such as fluorine, into host matrix 10, the optical properties of host matrix 10 and the resulting composite material are improved over conventional composite materials. Unlike the C—H bonds of hydrocarbon polymers, carbon-to-halogen bonds (such as C—F) shift the vibrational overtones toward longer wavelengths out of the ranges used in telecommunication applications. Specifically, the carbon-to-halogen bonds exhibit vibrational overtones having low absorption levels ranging from about 0.8 μm to about 0.9 μm, and ranging from about 1.2 μm to 1.7 μm. As hydrogen is removed through partial to total halogenation, the absorption of light by vibrational overtones is reduced. One parameter that quantifies the amount of hydrogen in a polymer is the molecular weight per hydrogen for a particular monomeric unit. For highly halogenated polymers useful in optical applications, this ratio may be 100 or greater. This ratio approaches infinity for perhalogenated materials.

Nanoparticles 11 may comprise various different materials, and they may be fabricated using several different methods. In one embodiment of the invention, the nanoparticles are produced using an electro-spray process. In this process, very small droplets of a solution including the nanoparticle precursor material emerge from the end of a capillary tube, the end of which is maintained at a high positive or negative potential. The large potential and small radius of curvature at the end of the capillary tube creates a strong electric field causing the emerging liquid to leave the end of the capillary as a mist of fine droplets. A carrier gas captures the fine droplets, which are then passed into an evaporation chamber. In this chamber, the liquid in the droplets evaporates and the droplets rapidly decrease in size. When the liquid is entirely evaporated, an aerosol of nanoparticles is formed. These particles may be collected to form a powder or they may be put into a solution. The size of the nanoparticles is variable and depends on processing parameters.

In an exemplary embodiment of the present invention, nanoparticles 11 have a major dimension of less than about 50 nm. That is, the largest dimension of the nanoparticle (for example the diameter in the case of a spherically shaped particle) is less than about 50 nm.

Other processes are also useful for making the nanoparticles 11 of the present invention. For example, the nanoparticles may be fabricated by laser ablation, laser-driven reactions, flame and plasma processing, solution-phase synthesis, sol-gel processing, spray pyrolysis, flame pyrolysis, laser pyrolysis, flame hydrolysis, mechanochemical processing, sono-electro chemistry, physical vapor deposition, chemical vapor deposition, mix-alloy processing, decomposition-precipitation, liquid phase precipitation, high-energy ball milling, hydrothermal methods, glycothermal methods, vacuum deposition, micro emulsion processes or any other suitable method for obtaining particles having appropriate dimensions and characteristics.

Several classes of materials may be used to form nanoparticles 11 depending upon the effect the nanoparticles are to have on the properties of the composite containing them. In one embodiment, nanoparticles 11 may include one or more active materials, which allow the composite to be a gain medium. Active materials amplify a light signal as the light signal encounters the active material. Active materials include rare-earth containing compounds or ions, and chromium compounds or chromium ions. Rare-earth as used herein is understood to include yttrium and scandium. Active materials also include V³⁺, Cr³⁺, Cr⁴⁺, Co²⁺, Fe²⁺, Ni²⁺, Ti³⁺, and Bi³⁺.

The phonon energy, emission window, and quantum efficiency are dependent on the host system that Dy, Pr and Nd are doped into. For example, Pr doped into ZBLAN (ZrF₄—BaF₂—LaF₃—AlF₃—NaF) has a quantum efficiency of 3%, while Pr in some other fluoride glasses (e.g. GdF₃, ZnF₂ based glasses) has quantum efficiency of about 6%. Pr in sulfide glasses can have efficiency of 50-70%. Dy doped fluoride and oxides have quantum efficiency of less than 1%. Dy doped sulfide glasses have quantum efficiency of 17-19%. Dy doped LaClₛ, SrCl₃, KPb₂Cl₅ crystals have quantum efficiencies of 20-80%.

In certain embodiments, Praseodymium, Dysprosium, and Neodymium alone or together may be incorporated in a nanoparticle for amplification ranging from about 1.27 μm to about 1.35 μm, and further about 1.3 μm, and yet further about 1.31 μm.

In other embodiments, Praseodymium, alone or together with other rare-earth elements may be incorporated in a nanoparticle for amplification ranging from about 1.27 μm to about 1.35 μm, and further about 1.3 μm, and yet further about 1.31 μm.

In further embodiments, Dysprosium alone or together with other rare-earth elements may be incorporated in a nanoparticle for amplification ranging from about 1.27 μm to about 1.35 μm, and further about 1.3 μm, and yet further about 1.31 μm.

In yet further embodiments, Neodymium alone or together with other rare-earth elements may be incorporated in a nanoparticle for amplification ranging from about 1.27 μm to about 1.35 μm, and further about 1.3 μm, and yet further about 1.31 μm.

In another embodiment, Praseodymium, Dysprosium, and Neodymium alone or together with other rare-earth elements, such as Ytterbium, may be incorporated in a nanoparticle for amplification ranging from about 1.27 μm to about 1.35 μm, and further about 1.3 μm, and yet further about 1.31 μm.

In certain embodiments, Praseodymium, Dysprosium, and Neodymium are each alone or together co-doped with other active ions in crystal nanoparticles for amplification ranging from about 1.27 μm to about 1.35 μm, and further about 1.3 μm, and yet further about 1.31 μm. In another embodiment, several separate species of nanoparticles containing an active ion such as Dy, Pr, Nd, and Yb, and other active ions may be doped into the polymer hosts.

The material that forms the matrix of nanoparticle 11 may be in the form of an ion, alloy, compound, or complex, and may comprise the following: an oxide, phosphate, halophosphate, phosphinate, arsenate, sulfate, borate, aluminate, gallate, silicate, germanate, vanadate, niobate, tantalite, tungstate, molybdate, alkalihalogenate, halogenide, nitride, selenide, sulfide, sulfoselenide, tetrafluoroborate, hexafluorophosphate, phosphinate, and oxysulfide.

Semiconductor compounds may also be used to form nanoparticles 11. These materials include, for example, Si, Ge, SiGe, GaP, GaAs, InP, InAs, InSb, PbSe, PbTe, and other semiconductor materials.

Metals such as Ag, Au, Os, W, Al, and Pd, as well as metal chalocogenides, metal salts, transition metals, transition metal complexes, transition metal containing compounds, transition metal oxides, and organic dyes, such as, for example, Rodamin-B, DCM, Nile red, DR-19, and DR-1, and polymers may be used. PbS and PbS doped with a rare-earth or transition metal for optical amplification can also be used to form nanoparticles. Additionally, oxides such as TiO₂ and SiO₂ may also be used.

In one embodiment of an amplifier according to the present invention, the nanoparticles are coated with a polymer, such as a halogenated polymer. In certain embodiments, the coated nanoparticles comprise one or more active materials. The coated nanoparticles may also have a negative CTE (coefficient of thermal expansion). Coated nanoparticles comprising active materials find particular utility as low phonon energy gain media.

In another embodiment, the nanoparticles are comprised of a sulfide and coated with a polymer, such as a halogenated polymer. Among the sulfide reagents, examples include Sodium Sulfide, Zinc Sulfide, Lead Sulfide, or any other sulfide salts thereof. An embodiment for making the sulfide nanoparticles used as low phonon energy gain media comprises, dissolving a precursor of at least one active material in a first solvent, such as a hydrocarbon or a polar hydrocarbon. The first solvent may comprise an alcohol, such as methanol or ethanol. A halogenated thiol, such as a fluorinated thiol, is dissolved in a second solvent to create a thiol solution. The second solvent may comprise a hydrocarbon solvent, which is miscible with the first solvent.

The second solvent may comprise, for example toluene, chlorobenzene, dichlorobenzene, or tetrahydrafuran. In the embodiment the thiol solution is added to the dissolved precursor to form a reaction mixture. Adding the thiol solution occurs in a dropwise fashion into the dissolved precursor and the reaction mixture is vigorously stirred. Dropwise indicates that the solution is added drop-by-drop. A hydrocarbon with halogen substitution (referred to herein as a halocarbon), such as a solvent comprising a fluorocarbon, is then added to the reaction mixture followed by the addition of water to create a halocarbon phase which is rinsed at least once with water. The method further comprises separating the halocarbon phase from the aqueous phase.

The separation may be accomplished in a number of conventional ways that need not be discussed herein. In this embodiment, a sulfide reagent is then added to the halocarbon phase to form a sulfide halocarbon reaction mixture. An example of a sulfide reagent is Na₂S in a third solvent. The third solvent may comprise a hydrocarbon, such as an alcohol, for example methanol or ethanol.

The sulfide reagent halocarbon reaction mixture is then stirred and washed with water. Sulfide nanoparticles in the halocarbon phase can then be collected and dried. In one embodiment, the sulfide nanoparticles can be dried at a pressure below 1 atmosphere. Additionally, the sulfide nanoparticles may include a coating. In certain embodiments the coating comprises a halogenated polymer, for example, a fluorinated thiol.

In certain embodiments, the coated sulfide nanoparticles further include a coating made from a fluorocarbon moiety (a “fluorocoated” particle). The fluorocoated sulfide nanoparticles can be manufactured by adding fluorinated thiol to a NaH suspension in an anhydrous hydrocarbon solvent to form a first mixture. In certain embodiments, the fluorinated thiol can be added in a drop-wise fashion. Halides or acetates comprising active materials can be added to the first mixture to form a reaction mixture. Other active materials may also be used either separately or in combination with at least one other active material. The reaction mixture can be exposed to nitrogen and mixed at a temperature ranging from about 10° C. to about 100° C. Mixing can be accomplished by stirring the reaction mixture from about 1 hour to about 72 hours. An aliquot, or fractional amount of the reaction mixture, can then be removed from the reaction mixture and byproducts of the reaction extracted using, for example, water. Adding water facilitates the removal of NaCl. A sulfide reagent is then added and the reaction mixture is stirred. An example of the sulfide reagent comprises Na₂S. Using processes of this embodiment, sulfide nanoparticles having a major dimension of less than about 500 nm can be formed. More particularly, sulfide nanoparticles of about 3 nm to about 102 nm are formed.

In another embodiment, a thiol can be added in a drop-wise fashion to a suspension comprising NaH in 20 ml of anhydrous toluene to form a first mixture. After about 10 min, Rare-earth chlorides can be added to the first mixture to form a reaction mixture. The reaction mixture is then exposed to nitrogen and stirred for about 2 to 3 hours. Following the stirring, an aliquot of the reaction mixture is removed and byproducts extracted with water. The water also aids in removing NaCl. A sulfide reagent comprising Na₂S is added and the reaction mixture reacts while being stirred. In this example, the reaction continues for about 60 hours to about 70 hours. About 25 ml of toluene with about 25 ml of deionized water is added to the reaction mixture and stirred. Because toluene and water are not miscible, layers of toluene can be removed along with byproducts, such as NaCl, with the water. Sediment forms with the toluene layers. About 11 g (or about 0.139 mmol) Na₂S in about 7 ml MeOH (with a ratio of Rare-Earth Cl₃:Na₂S of about 1:0.1) is added to the toluene layer with sediment, which is then stirred for about 25 min to about 35 min. Because water and toluene are not miscible with each other, adding water causes the formation of two layers, or phase separation in the reaction mixture. Thus deionized water is added for promote phase separation. The phase separated mixture of toluene layers and water is boiled to extract coated sulfide nanoparticles that come into the toluene layer. The coated sulfide nanoparticles can be filtered through a filter. In such an embodiment, the coating on the sulfide nanoparticles comprises a halogenated polymer.

In an embodiment of the present invention, coated sulfide nanoparticles dispersed in a matrix can be used as a gain medium. In such embodiments, the matrix comprises a host matrix and the sulfide nanoparticles include a coating of a halogenated polymer.

Inclusion of nanoparticles 11 into host matrix material 10, at least in one particular application, may provide a composite material useful in optical waveguide applications. For example, nanoparticles 11 provide the capability of fabricating a waveguide material having a particular index of refraction. By controlling the index of refraction in this way, transmission losses in optical waveguides resulting from index of refraction mismatches in adjacent materials could be minimized. Additionally, because of the small size of nanoparticles 11, the composite material may retain all of the desirable transmission properties of halogenated matrix material 10. Using the nanoparticles disclosed herein, the index of refraction is tuned to from about 1 to about 5.

In optical waveguide applications, the major dimension of the nanoparticles described herein is smaller than the wavelength of light used. Therefore, light impinging upon nanoparticles 11 will not interact with, or scatter from, the nanoparticles. As a-result, the presence of nanoparticles 11 dispersed within the host matrix material 10 has little or no effect on light transmitted through the host matrix. Even in the presence of nanoparticles 11, the low absorption loss of host matrix 10 may be maintained.

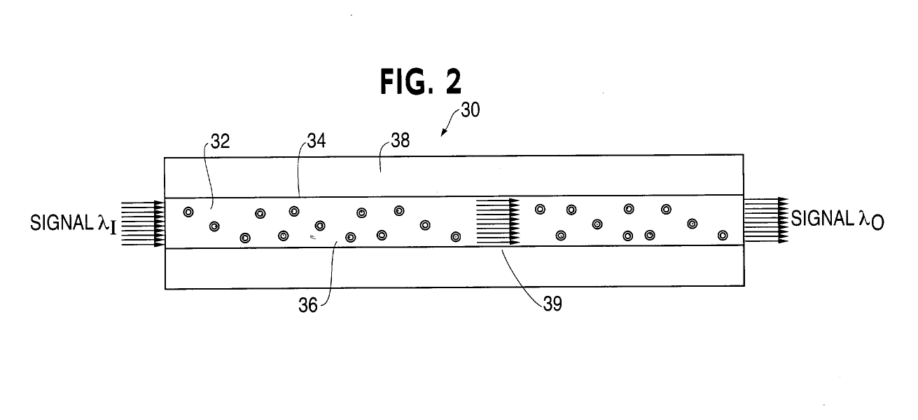

FIG. 2 shows a schematic cross-sectional view of a planar optical waveguide 30 formed using the nanoparticles. A cladding 38 surrounds a core 32 comprised of a host matrix 34 containing the coated nanoparticles 36. In one embodiment, the cladding 38 has a lower index of refraction than core 32. In this embodiment, the nanoparticles added to core 32 increase the index of refraction of the material comprising core 32.

In such an embodiment, input light λ₁ is injected into the waveguide 30 at one end. The input light λ₁ is confined within the core 32 as it propagates through core 32. The small size of the nanoparticles allows the input light λ₁ to propagate without being scattered, which would contribute to optical power loss. Input light λ₁ interacting with the nanoparticles 36, thus, amplifying the light signal shown schematically at 39.

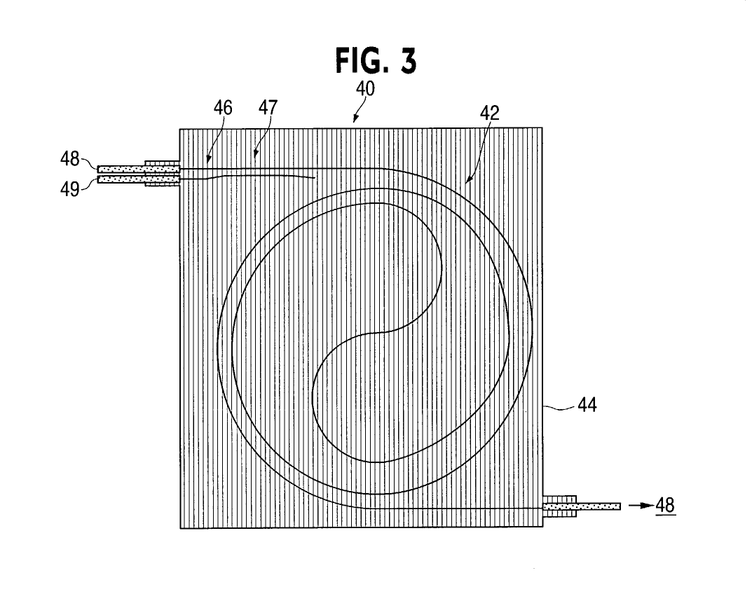

FIG. 3 shows another embodiment of the invention, a curved waveguide amplifier 40 for optical amplification using a core (not shown) comprised of a host matrix containing doped nanoparticles. In this embodiment, the matrix comprises a host matrix material and the coating of the nanoparticles comprises a halogenated polymer material. A curved waveguide 42 on a substrate 44 allows a relatively long amplification waveguide path length in a relatively small area. In certain embodiments, the substrate 44 may comprise a polymer. Those skilled in the art may employ, for example the method of lines, or simple geometric principals when choosing the optimum layout for curved amplifiers according to the present invention.

In another embodiment a direction wavelength divisional multiplexer (WDM) coupler 46 is placed on a waveguide chip 47 to combine a signal light λₛ 48 and a pump light λₚ 49. The pump light λₚ 49 stimulates the active material included in the doped nanoparticles in the core to amplify the signal light λₛ 48.

When the nanoparticles in the core comprise one or more of the active materials, a wavelength of the signal light is a broadband signal ranging from about 0.8 μm to about 0.9 μm, and further from about 1.2 μm to about 1.7 μm is amplified. When the nanoparticles in the core comprise at least on material chosen from Dy and Pr, a wavelength of the signal light ranging from about 1.28 μm to about 1.36 μm, and further, from about 1.30 μm to about 1.32 μm is amplified. When the nanoparticles in the core comprise Erbium, the wavelength of the signal light ranging from about 1.50 μm to about 1.62 μm, and further ranging from about 1.53 μm to about 1.56 μm is amplified. In a further embodiment, the nanoparticles in the core may comprise one or more active materials. The index of refraction of the core and/or cladding may be adjusted to a desired value with the inclusion of nanoparticles.

Generally, the index of refraction of a composite that includes nanoparticles of appropriate compositions can be adjusted to different selected values. For example, adding nanoparticles disclosed herein to the host matrix will tune the refractive index of the composite to be from 1 to about 5. As a result, the nanocomposite material is suitable for use in various optical applications such as waveguides according to the present invention. The index of refraction for the nanoparticles may be determined using techniques known to one of ordinary skill in the art. Three such techniques include, diffuse reflectance, metricon or elipsometer measurements, and index matching fluids.

For example, the amplifier may comprise a host matrix having a refractive index, nₘₐₜᵣᵢₓ and a plurality of nanoparticles dispersed within the host matrix having a refractive index n_{particle}. In this embodiment, the host matrix and the plurality of nanoparticles form a composite having a refractive index, n_{comp}, where nₘₐₜᵣᵢₓ is not equal to n_{particle}. Further, the nanoparticles within the host matrix are in such an amount sufficient to result in a value for n_{comp}, which is different from nₘₐₜᵣᵢₓ.

In another embodiment, a nanocomposite material can be fabricated that has a high index of refraction and low absorption loss, for example less than approximately 2.5×10⁻⁴ dB/cm in the range from about 1.2 μm to about 1.7 μm. As previously stated, halogenated polymers, including fluorinated polymers, exhibit very little absorption loss (see Table 1).

TABLE 1
Wavelengths and intensities of some important vibrational overtones

| Bond | n | Wavelength (nm) | Intensity (relative) |
|---|---|---|---|
| C—H | 1 | 3390 | 1 |
| C—H | 2 | 1729 | 7.2 × 10⁻² |
| C—H | 3 | 1176 | 6.8 × 10⁻³ |
| C—F | 5 | 1626 | 6.4 × 10⁻⁶ |
| C—F | 6 | 1361 | 1.9 × 10⁻⁷ |
| C—F | 7 | 1171 | 6.4 × 10⁻⁹ |
| C═O | 3 | 1836 | 1.2 × 10⁻² |
| C═O | 4 | 1382 | 4.3 × 10⁻⁴ |
| C═O | 5 | 1113 | 1.8 × 10⁻⁵ |
| O—H | 2 | 1438 | 7.2 × 10⁻² |

Therefore, these halogenated polymers may be particularly suitable for transmitting light in optical waveguides and other applications according to the present invention. In such applications, nanoparticles 11 are smaller than the wavelength of incident light. Therefore, light impinging upon nanoparticles 11 will not interact with, or scatter from, the nanoparticles. As a result, the presence of nanoparticles 11 dispersed within the halogenated matrix material 10 has little or no effect on the optical clarity of the composite, even if the nanoparticles themselves comprise material, which in bulk form would not be optically clear, or even translucent. Thus, even in the presence of nanoparticles 11, the low absorption loss of host matrix 10 may be maintained.

By contrast, the presence of nanoparticles 11 within halogenated matrix material 10 may contribute to significantly different properties as compared to the host matrix material alone. For example, as already noted, nanoparticles 11 may be made from various semiconductor materials, which may have index of refraction values ranging from about 1 to about 5. Upon dispersion of nanoparticles 11 into halogenated matrix material 10, the resulting composite material will have an index of refraction value somewhere between the index of refraction of halogenated matrix material 10 (usually less than about 2) and the index of refraction of the nanoparticle material. The resulting, overall index of refraction of the composite material will depend on the concentration and make-up of nanoparticles 11 within halogenated matrix material 10. For example, as the concentration of nanoparticles 11 in halogenated matrix material 10 increases, the overall index of refraction may shift closer to the index of refraction of the nanoparticles 11. Other materials, for example, gold, silver, or copper, having a refractive index n_{particle} that is less than nₘₐₜᵣᵢₓ, can be used to provide a composite index of refraction n_{comp} that is less than the refractive index nₘₐₜᵣᵢₓ of the host matrix. The value of n_{comp} can differ from the value of nₘₐₜᵣᵢₓ by a range of about 0.2% to about 330%. In an exemplary embodiment, the ratio of n_{particle}:nₘₐₜᵣᵢₓ is at least 3:2. In another exemplary embodiment, the ratio of n_{particle}:nₘₐₜᵣᵢₓ is at least 2:1.

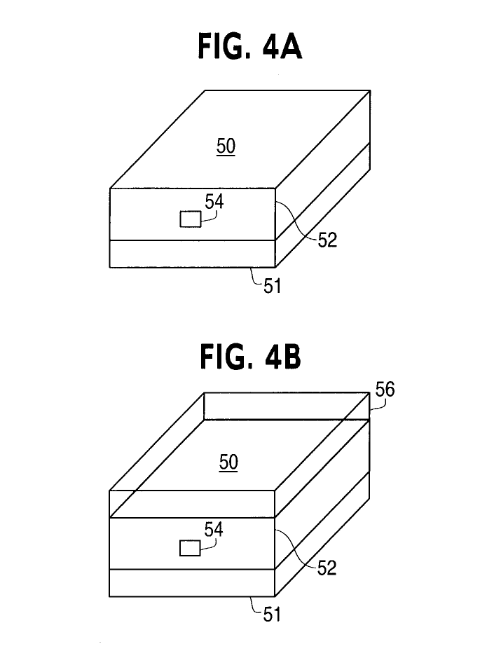

FIG. 4 schematically illustrates an optical waveguide 50 according to one embodiment of the present invention. Optical waveguide 50 includes a generally planar substrate 51, a core material 54 for transmitting incident light and a cladding material 52 disposed on the substrate 51, which surrounds the core 54 and promotes total internal reflection of the incident light within the core material 54. The core 54 of the optical waveguide may be formed of a nanocomposite as illustrated, for example, in FIG. 1

The cladding 51 and 52 may be each independently composed of an optical polymer, such as a perfluorinated polymer. The waveguide core 54 may be composed of a nano-composite material for example doped glass, single crystal, or polymer particles with dimensions ranging from about 1 nm to about 100 nm are embedded in a polymer waveguide core. Said dopant may comprises at least one material chosen from Pr, Dy, and Nd

In such an embodiment, the core 54 may include a host matrix and a plurality of nanoparticles dispersed within the host matrix. A majority of the plurality of nanoparticles present in core 54 includes a halogenated outer coating layer. The cladding material in this embodiment comprises a host matrix. In certain embodiments, the cladding material may further include nanoparticles dispersed in a host matrix in such a way that the relative properties of the core and cladding can be adjusted to predetermined values.

Further, in one embodiment of the present invention, the host matrix material of the core 54 and/or cladding layer 52 includes fluorine. The nanoparticles in the optical waveguide 50 may have an index of refraction of ranging from about 1 to about 5. By selecting a particular material having a particular index of refraction value, the index of refraction of the core 54 and/or cladding layer 52 of the optical waveguide 50 may be adjusted to a predetermined desired value or to different predetermined values.

Many materials expand when heated, and contract when cooled. The CTE is the ratio of the change in length (due to expansion or contraction) per unit temperature. For example, materials that expand when heated are said to have a positive CTE. Similarly, materials that contract when heated exhibit a negative CTE.

A mismatch between the CTE's of the materials comprising the composite can have a degrading effect on the composite materials. Both nanoparticles and polymer matrices have a CTE. Thermal expansion and contraction can lead to degradation of the mismatched CTE's composite materials comprising the nanoparticles. For example, when two materials, such as two different polymer matrices, each having different positive CTE's are adjacent to each other, stress can occur between the materials due to the differing expansion rates.

Nanoparticles comprising materials having different CTE's can be used to adjust the CTE of a composite comprising the nanoparticles. In certain embodiments, nanoparticles comprised of materials having a negative CTE can be used in combination with nanoparticles comprised of materials having a positive CTE to adjust the CTE of the composite containing the nanoparticles.

The nanoparticles 11 may comprise materials having positive or negative thermal expansion coefficients. When nanoparticles having negative CTE's are combined with a matrix material and/or nanoparticles having positive CTE's, the resulting composite material will have a CTE between that of the negative CTE material and that of the positive CTE material. The negative CTE material need not be sized with the scale of nanoparticles. It may be sized larger than the scale of nanoparticles. In one embodiment, the CTE of the composite may therefore be controlled by choosing materials for the host matrix and/or nanoparticles having different relative CTE, and by varying the amounts of these materials within the host matrix.

The amount and type of materials comprising the nanocomposite may be chosen so that the nanocomposite exhibits little or no expansion or contraction (in other words, a CTE that is substantially zero) when cycled through various thermal environments. Alternatively, the host matrix material and the nanoparticles may be chosen to provide a composite having a specific positive or negative CTE.

Among materials having negative CTE's, examples include Ni—Ti alloys, ZrW₂O₈, ZrMo₂O₈, Y₂(WO₄)₃, V doped ZrP₂O₇, ZrV₂O₇, (Zr₂O)(PO₄)₂, Th₄(PO₄)₄P₂O₇, and AOMO₄, where A=Nb or Ta, and M=P, As, or V. Nanoparticles 11 formed from these materials exhibit a negative CTE, and therefore their dimensions shrink as temperature increases. One exemplary embodiment of materials exhibiting a negative CTE are the materials corresponding to formula (I) below:

A_{1-y}⁴⁺A_{y}¹⁺A_{y}³⁺V₂₋ₓPₓO₇ (I)

where:

A⁴⁺is chosen form Hf, Zr, ZrₐMb, or HfₐM_{b} and mixtures thereof,

a+b=1.

A¹⁺ is chosen form alkali earth metals,

A³⁺ is chosen form rare-earth metals,

M is chosen form Ti, Ce, Th, U, Mo, Pt, Pb, Sn, Ge or Si

y ranges from about 0 to about 0.4,

x ranges from about 0.6 to about 1.4,

Among the materials falling within formula (I), examples include (ZrO)₂VP₂O₇, ZrVPO₇, Zr_{0.8}Li_{0.2}Y_{0.2}VPO₇, Zr_{0.8}Ce_{0.2}VPO₇, and HfVPO₇.

In one embodiment for controlling the CTE of the composite material, the amount of nanoparticles may range from approximately 10% to about 95% by volume of the composite material. These particles may comprise particles chosen to have a negative CTE. In another embodiment, one or more of the particles are chosen to have a negative CTE, and the remaining particles have a positive CTE. In yet another embodiment, the negative CTE material comprises particles that are larger than nanoparticle-sized, and ranging from about 5% to about 99% by volume of the composite material.

As show in FIG. 4B optical waveguide 50 may optionally include a superstrate 56 disposed on the top of cladding 52. To minimize the variation in the wavelength response of optical waveguide 50 to environmental temperature changes, the CTE of at least one of substrate 51, cladding 52, core 54, and superstrate 56 may be controlled by the inclusion of nanoparticles. Specifically, at least one of substrate 51, cladding 52, core 54, and superstrate 56 includes a host matrix and a plurality of nanoparticles dispersed within the host matrix. By selecting a particular nanoparticle material having a particular CTE and a specific amount of the particular nanoparticles, the overall CTE of substrate 51, cladding 52, core 54, and superstrate 56 of optical waveguide 50 may be adjusted to a desired value. The plurality of nanoparticles may include a halogenated outer coating layer. Further, in one embodiment of the present invention, the host matrix material of at least one of substrate 51, cladding 52, core 54, and superstrate 56 includes fluorine.

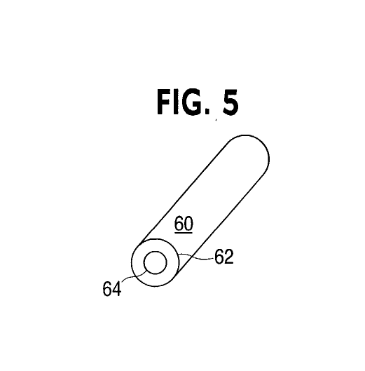

FIG. 5 illustrates an optical waveguide 60 according to another embodiment of the present invention. Optical waveguide 60 comprises an optical fiber with a core 64 surrounded by a cladding 62. The core includes a host matrix and a plurality of nanoparticles dispersed within the host matrix. In one embodiment, core 64 comprises nanoparticles. The cladding material in this embodiment comprises a host matrix. In certain embodiments, the cladding material may also comprise nanoparticles dispersed in a host matrix. Further, in one embodiment of the present invention, the host matrix material of the core 64 and/or cladding layer 62 includes fluorine. The plurality of nanoparticles in the optical waveguide 60 may have an index of refraction ranging from about 1 to about 5. By selecting a particular material having a particular index of refraction value, the overall index of refraction of the core 64 of the optical waveguide 60 may be adjusted to a predetermined desired value or to different predetermined values.

In addition to the materials mentioned, still other materials are useful as nanoparticles 11. For example, the nanoparticles, themselves, may comprise a polymer. In an exemplary embodiment of the invention, the polymer nanoparticles comprise polymers that contain functional groups that can bind ions, such as rare-earth ions. Such polymers include homopolymers or copolymers of vinyl, acrylic, vinyl aromatic, vinyl esters, alpha beta unsaturated acid esters, unsaturated carboxylic acid esters, vinyl chloride, vinylidene chloride, and diene monomers. The reactive groups of these polymers may comprise any of the following: POOH, POSH, PSSH, OH, SO₃H, SO₃R, SO₄R, COOH, NH₂, NHR, NR₂, CONH₂, NH—NH₂, and others, where R may be chosen from linear or branched hydrocarbon-based chains, possibly forming at least one carbon-based ring, being saturated and unsaturated, aryl, alkyl, alkylene, siloxane, silane, ether, polyether, thioeter, silylene, and silazane.

The polymers for use as nanoparticles may alternatively comprise main chain polymers containing rare-earth ions in the polymer backbone, or side chain or cross-linked polymers containing the above-mentioned functional groups. Additionally, the nanoparticles may comprise organic dye molecules, ionic forms of these dye molecules, or polymers containing these dye molecules in the main chain or side chain, or cross-linked for applications in electro-optical materials. When the nanoparticles comprise polymers that are not halogenated, they may be optionally coated with a halogenated coating as described herein.

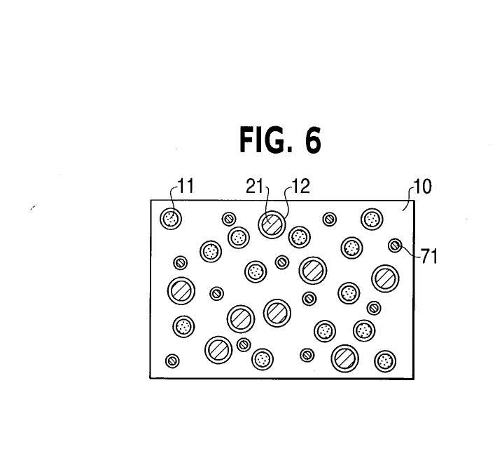

Composite materials comprising the amplifiers of the present invention may contain different types of nanoparticles. For example, FIG. 6 illustrates an exemplary embodiment of the present invention in which several groups of nanoparticles 11, 21, and 71 are present within halogenated matrix 10. Each group of nanoparticles 11, 21 and 71 is comprised of a different material surrounded by an outer layer (for example, layer 12 on particle 21).

Nanocomposites fabricated from several different nanoparticles may offer properties derived from the different nanoparticles. For example, nanoparticles 11, 21, and 71 may provide a range of different optical, structural, or other properties. Such an arrangement may be useful, for example to form broadband optical amplifiers and other optical devices according to the present invention. One skilled in the art will recognize that the present invention is not limited to a particular number of different types of nanoparticles dispersed within the host matrix material. Rather, any number of different types of nanoparticles may be useful in various applications.

Depending on the end use, the nanoparticles according to the present invention may be bare, or contain at least one outer layer. As shown in FIG. 1, the nanoparticles may include an outer layer 12. The layer 12 may serve several important functions. It may be used to protect nanoparticle 11 from moisture or other potentially detrimental substances. Additionally, layer 12 may also prevent agglomeration. Agglomeration is a problem when making composite materials that include nanoparticles distributed within a matrix material.

In one embodiment, by selecting a layer 12 of a material that is compatible with a given host matrix material, layer 12 may eliminate the interfacial energy between the nanoparticle surfaces and host matrix 10. As a result, the nanoparticles in the composite material do not tend to agglomerate to minimize the interfacial surface area/surface energy that would exist between uncoated nanoparticles and host matrix material 10. Layer 12, therefore, enables dispersion of nanoparticles 11 into host matrix material 10 without agglomeration of the nanoparticles.

When the outer layer 12 is halogenated, it may comprise at least one halogen chosen from fluorine, chlorine, and bromine. In an exemplary embodiment of the present invention, the halogenated outer layer 12 may include, for example, halogenated polyphosphates, halogenated phosphates, halogenated phosphinates, halogenated thiophosphinates, halogenated dithiophosphinates, halogenated pyrophosphates, halogenated alkyl titanates, halogenated alkyl zirconates, halogenated silanes, halogenated alcohols, halogenated amines, halogenated carboxylates, halogenated amides, halogenated sulfates, halogenated esters, halogenated acid chloride, halogenated acetylacetonate, halogenated disulfide, halogenated thiols, and halogenated alkylcyanide. While fluorine analogs of these materials can be used, analogs of these materials incorporating halogens other than fluorine, as well as hydrogen, may also be employed in outer layer 12.

In addition to protecting the nanoparticles 11 and suppressing agglomeration, layer 12 may also be designed to interact with the surfaces of nanoparticles 11. For example, halogenated outer layer 12 may comprise a material, such as one of the above listed layers, which reacts with and neutralizes an undesirable radical group, for example OH or esters, that may be found on the surfaces of nanoparticles 11. In this way, layer 12 may prevent the undesirable radical from reacting with host matrix 10. Coating 82 may also prevent fluorescence quenching in the case of fluorescence nanoparticles.

Coatings on nanoparticles 11 are not limited to a single layer, such as halogenated outer coating layer 12 shown in FIG. 1. Nanoparticles may be coated with a plurality of layers.

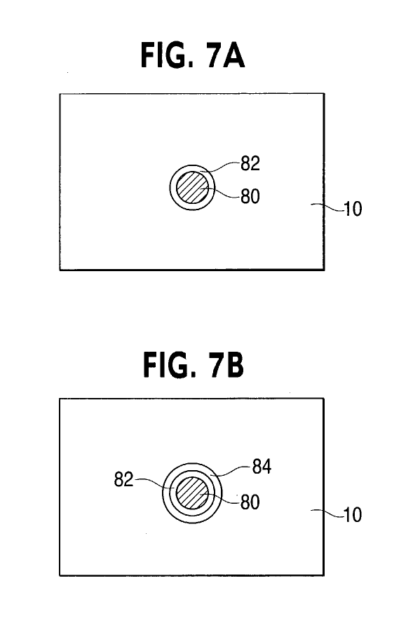

FIG. 7 schematically depicts one nanoparticle suspended within host matrix material 10. As shown, inner layer 84 is disposed between nanoparticle 80 and halogenated outer layer 82. In certain situations the interaction between a particular nanoparticle material 80 and a particular halogenated outer layer 84 may be unknown. In these situations, nanoparticles 80 may be coated with an inner coating layer 84 comprising a material that interacts with one or both of the nanoparticle material and the halogenated outer coating layer material in a known way to create a passivation layer. Such an inner coating layer may prevent, for example, delamination of the halogenated outer coating layer 82 from nanoparticle 80. While inner coating layer 84 is shown in FIG. 7 as a single layer, inner coating layer 84 may include multiple layers of similar or different materials.

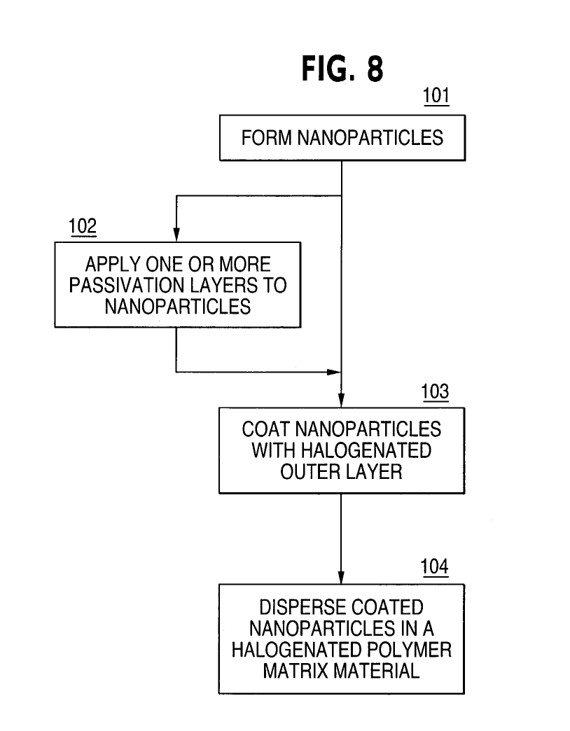

FIG. 8 is a flowchart diagram representing process steps for forming a composite material according to an exemplary embodiment of the present invention. Nanoparticles 11, as shown in FIG. 1 are formed during step 101. Once formed, nanoparticles 11 are coated with a halogenated outer layer 12 at step 103. Optionally, at step 102, an inner coating layer 84 (or passivation layer), as shown in FIG. 7, may be formed on the nanoparticles 80. Inner coating layer 84, which may include one or more passivation layers, may be formed prior to formation of halogenated outer layer 82 using methods similar to those for forming halogenated outer layer 82.

Nanoparticles may be coated in several ways. For example, nanoparticles may be coated in situ, or, in other words, during the formation process. The nanoparticles may be formed (for example by electro-spray) in the presence of a halogentated coating material. In this way, once nanoparticles 11 have dried to form an aerosol, they may already include layer 12 of the desired halogenated material.

In one embodiment, layer 12 may be formed by placing the nanoparticles into direct contact with the coating material. For example, nanoparticles may be dispersed into a solution including a halogenated coating material. In some embodiments, nanoparticles may include a residual coating left over from the formation process. In these instances, nanoparticles may be placed into a solvent including constituents for forming the halogenated outer layer. Once in the solvent, a chemical replacement reaction may be performed to substitute halogenated outer layer 12 for the preexisting coating on the plurality of nanoparticles 11. In one embodiment, nanoparticles may be coated with a coating in a gas phase reaction, for example, in a gas phase reaction of hexamethyldisilizane.

In another embodiment, the nanoparticles may be dispersed by co-dissolving them, and the host matrix, in a solvent (forming a solution), spin coating the solution onto a substrate, and evaporating the solvent from the solution.

In another embodiment, the nanoparticles may be dispersed in a monomer matrix, which is polymerized after the dispersion.

In yet another embodiment, coatings may be in the form of a halogenated monomer. Once the monomers are absorbed on the surface of the particles, they can be polymerized or cross-linked. Additionally, coatings in the form of polymers can be made by subjecting the particles, under plasma, in the presence of halogenated monomers, to form coated nanoparticles with plasma induced polymerization of the particle surface. The coating techniques described are not intended to be an exhaustive list. Indeed, other coating techniques known to one of ordinary skill in the art may be used.

Once nanoparticles have been formed and optionally coated, they are dispersed into host matrix at step 104. To obtain a uniform distribution of nanoparticles within host matrix, a high shear mixer or a sonicator may be used. Such high shear mixers may include, for example, a homogenizer or a jet mixer.

Another method of dispersing nanoparticles throughout the host matrix is to co-dissolve the nanoparticles with a polymer in a suitable solvent, spin-coating the solution onto a substrate, and then evaporating the solvent to form a polymer nanocomposite film.

Yet another method of dispersing nanoparticles throughout the host matrix is to disperse nanoparticles into a monomer, and then polymerize the monomer to form a nanocomposite. The monomer can be from the group comprising halogenated methacrylate, halogenated acrylate, halogenated styrene, halogenated substituted styrene, trifluorovinyl ether monomer, epoxy monomer with a cross-linking agent, and anhydride/diamine, although those skilled in the art will recognize that other monomers can be used as well. The dispersion techniques described are not intended to be an exhaustive list. Indeed, other dispersion techniques known to one of ordinary skill in the art can be used.

In one embodiment of the present invention, the host matrix may comprise various types of nanoparticles. For example, in certain embodiments the host matrix may comprise particles and/or nanoparticles having positive and/or negative CTE. In other embodiments the index of refraction of the host matrix can be adjusted by including a single type, or various types, of nanoparticles where the nanoparticles comprise an index of refraction. The host matrix may also comprise nanoparticles comprising active materials. In addition, in certain embodiments, the host matrix may comprise nanoparticles comprising sulfides. Embodiments of the present invention also include matrices comprising particles and/or nanoparticles comprising positive and/or negative CTE, and/or various nanoparticles comprising various indexes of refraction, and/or active materials, and/or sulfides. In certain embodiments the nanoparticles comprise coatings, while in other embodiments, the nanoparticles have no coating. In addition, in certain embodiments, the matrices may be halogenated or non-halogenated. Thus, different combinations are explicitly considered.

In another embodiment according to the present invention, the polymer nanocomposites comprising a host matrix and nanoparticles of various functionalities may offer improvement in gain medium: Due to the low optical loss, the polymer nanocomposites based on a fluoropolymer host matrix may offer a superior gain medium when doped with active nanoparticles comprising at least one material chosen from rare-earth elements, transition metal elements, and group Il-VI ions.

In another embodiment of the amplifiers according to the present invention, the polymer nanocomposites comprising a host matrix and nanoparticles of various functionalities may further offer improvement in electro-optic properties, when the host matrix materials are doped with particles that exhibit electro-optic properties. The resulting nanocomposite offers the advantage of low optical loss, good film forming properties, low water absorptivity, thermal stability, and low term chemical resistance. Examples of suitable dopants include lithium niobate, GaAs, non-linear optical chromophores and organic dyes (derivatives of dithiophene, diphenoquinoid, anthraquinodimethane, etc.).

The present invention further comprises a method for making an optical waveguide amplifier comprising: a composite material comprising, a host matrix, a plurality of nanoparticles; doping said nanoparticles with at least material chosen from Dysprosium and Praseodymium; selecting said nanoparticles for 1.3 micron amplification; and adding said plurality of nanoparticles to the host matrix.

In yet another embodiment, the polymer nanocomposites comprising a host matrix and nanoparticles of various functionalities may further offer improvement in magneto-optic properties. Materials suitable for use as an optical isolator usually contain a critical magneto-optical property possessing a Faraday effect, allowing light in the forward propagation direction of the transmission line but blocking light propagating in the backward direction. Optical isolators are critical components in the transmission line for controlling and managing destabilizing effects of backward reflected light beams. Further, such isolators are commonly realized in the form of bulky inorganic single crystals as opposed to thin films or fibers.

Examples of such magneto-optical materials include YVO₄, TbPO₄, HoYbBiIG, (Cd,Mn,Hg)Te, MnAs, Y_{2.82}Ce_{0.18}Fe₅O₁₂, Bi-substituted iron garnet, Yttrium Iron Garnet, Terbium Gallium Garnet, Lithium Niobate, and paramagnetic rare-earth ions containing nanoparticles, such as Tb⁺³, y⁺³, or Ce⁺³.

In a further embodiment, the polymer nanocomposites comprising a host matrix and nanoparticles of various functionalities may offer improvement in optical properties. They form a new class of solid-state materials that can be realized not only as bulk materials, but also, importantly, as thin films and fibers. Magneto-optic polymer nanocomposites thus represent novel materials for optical isolators. In addition to discrete devices fabricated as bulk materials or fibers from these novel materials, optical isolators can now be designed and fabricated as a planar waveguide device components in integrated optical circuits. Such polymer nanocomposites would be critically advantageous in optical transmission lines in the control and management of signal transmission along fiber optic lines and networks.

In general, the materials used in making the amplifiers according the present invention are designed composites generally comprised of a polymer material having a high optical transparency that acts as a host matrix for incorporating one, or more, magneto-optic inorganic, organic, or polymer nanoparticles with one or more particles having a Faraday effect. Thus, for example, it is found that suitable nanoparticles, with some or all possessing a Faraday effect, can be introduced from about 10 volume % to about 95 volume % into a transparent polymer material to form a polymer nanocomposite of desired magneto-optical properties.

In another embodiment, the polymer nanocomposites comprising a host matrix and nanoparticles of various functionalities may further offer improvement in abrasion resistance properties. When fluoropolymers are doped with hard, inorganic materials such as SiO₂, TiO₂, YAG, etc, the polymer abrasion properties are enhanced by the presence of the inorganic components. These types of polymer composites offer additional advantages such as thermal and chemical stability, improved weatherability, and low water absorption when compared with conventional hydrocarbon based composites.

In yet another embodiment, the polymer nanocomposites comprising a host matrix and nanoparticles of various functionalities may further offer improvement in antireflective coatings. The inventive materials are designed optical polymer nanocomposites, generally comprised of an amorphous polymer material that exhibit high optical transparency over the three color fields and that acts at the same time as a host matrix for incorporating one, or more, coated inorganic, organic, or polymer nanoparticles with one, or more, particles incorporating a selected rare-earth ion in the wavelength regions of the three principal maxima of the optic cells, namely 450, 525, and 575 nm.

Examples of the rare-earth metals include Nd⁺³, Pr⁺³, Yb⁺³, and Ho⁺³. Thus, for example, it is found that suitable nanoparticles, with some or all possessing suitable optical absorption characteristics, can be introduced into the host matrix polymer composition ranging from about 0.1 to about 100 parts by weight of polymer. The light absorption performance of the optical polymer nanocomposite can be controlled by adjusting the concentrations and relative ratios of each of the rare-earth ions incorporated in the nanocomposite material. Consequently, the inventive materials have excellent anti-glare and transparency properties while appearing with little, or no, color due to the relatively low coloring coming from the adjusted rare-earth ions.

This invention can be adapted to make optical amplifiers, lasers, and dynamic gain equalizing filters, as well as other optical modules and components that may involve amplification.

Among the uses for the amplifiers comprising composite materials of the present invention, examples include windowpanes, mirrors and mirror panels optical lenses and lens arrays, optical displays, liquid crystal displays, cathode ray tubes, optical filters, and such components and modules.

An optical amplifier can be made consistent with this invention. An optical amplifier can amplify a modulated beam without opto-electronic and electro-optic conversion. In one embodiment, the device can use a length of an optical gain media, normally doped with excitable atoms (e.g., with rare-earth atoms and/or transition metal atoms, such as Ti, Cr, Fe, and Cu). Both integrated and free-space architectures can be fabricated consistent with this invention.

An optical fiber is one type of waveguide that can be used consistent with this invention. Another type of waveguide that can be used consistent with this invention is a planar waveguide. A planar waveguide core can have a cross-section that is, for example, substantially rectangular, substantially square, or any other shape that is conveniently fabricated. When a pump laser beam passes through the waveguide, external energy can be applied (e.g., at IR wavelengths), thereby pumping, or exciting, the excitable atoms in the gain medium and increasing the intensity of the signal beam passing there through. A signal beam emerging from the amplifier can retain most its original modulation characteristics, but is more intense than the input beam.

Many types of optical amplifiers can be made consistent with this invention, including narrow-band optical amplifiers, such as 1.3 μm optical amplifiers, and ultra-broadband amplifiers.

An ultra-broadband optical amplifier consistent with this invention can span more than about 60 nanometers. In one embodiment, such an amplifier can span more than about 400 nanometers, far more than the bandwidth of amplifiers used in conventional commercial wavelength-division multiplexed communications systems, which normally only span about 30 to 60 nanometers. An optical network that uses an ultra-broadband amplifier consistent with this invention can handle, for example, hundreds of different wavelength channels, instead of the 16 or so channels in conventional networks, thereby greatly increasing capacity and enhancing optical-layer networking capability. In the case of erbium-doped waveguides, seeded techniques can be used to broaden and shift the output wavelength to make a better L-band and broadband amplifier.

A laser can also be made consistent with this invention. As used herein, a laser includes a cavity with at least partially reflective surfaces (e.g., mirrors) at the ends and at least partially filled with an optical gain medium. The laser cavity sets up an optical resonant structure in which lasing activity begins when multiple reflections accumulate electromagnetic field intensity.

The gain medium can be any material (e.g., crystals, polymers, glasses, liquids, dyes, or gases) that includes atoms or molecules capable of being excited to a meta-stable state by light (i.e., optical pump) or an electric discharge. During operation, atoms emit light as they drop back to the ground state. This causes other nearby, excited atoms to do the same. In this way, the light is continually increased in intensity as it oscillates between the mirrors. If plane mirrors are used, the output beam is highly collimated. With concave mirrors, the output beam emerges from a focal point near one end of the cavity.

A dynamic gain equalizing (DGE) filter can be made consistent with this invention. A DGE can be used to ensure that all DWDM channels in a single fiber have approximately the same power level, which, in turn, helps to lower data error rates. Unfortunately, power levels become unequal as a signal travels through fiber-optic networks due to various optical components in the network, including optical amplifiers and various environmental factors.

The amplifiers of the present invention comprising composite materials of such as the fluoropolymers doped with nanoparticles and nanoparticles coated with fluorocarbon coatings offer advantages such as improved thermal stability, chemical resistance, low water absorptivity, and biocompatibility. These properties could provide improvements in applications such as (1) Gas Sensing: when the nanoparticles comprise ZnO, SnO₂, WO₃, TiO₂, Fe₂O₃, BiFeO₃, MgAl₂O₄, SrTiO₃, or Sr_{1-y}Ca_{y}FeO₃₋ₓ; (2) Magnetic Recording: when the nanoparticles comprise metallic particles such as CoPt, FePt, iron oxides; and (3) Drug Delivery: when nanoparticles comprise fluorocoated Au particles.

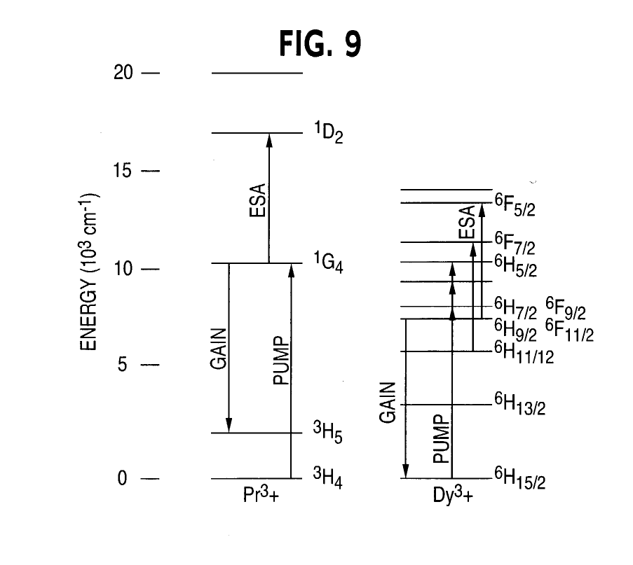

Rare-earth waveguide amplifiers operate on the basic 3-level and 4-level laser transition principles. The single pass gain of the waveguide amplifier is the fundamental parameter to be calculated. Amplification in a rare-earth-containing host matrix waveguide according to the present invention can be described with a 3-level model. FIG. 9 depicts the energy level diagrams of such a model for Pr and Dy.

FIG. 9 is a schematic illustration of the energy level diagram of Pr and Dy ions. The various glasses, crystals, liquid crystals, solvents, or polymer host matrices according to the present invention, are doped with at least one material chosen from Pr, Dy, and Nd. In the case of glasses, the preferred glasses are glasses with low phonon energies such as fluoride, zirconate, halide, chalcogenide, chalcohalide, and arsenic glasses. The method of doping rare-earth ions into the above listed glasses is well known to those skilled in the art. In the case of crystals, the preferred crystals include, but are not limited to Yttrium Aluminum Garnate: Dy (YAG:Dy), LaCl₃: Dy, KPb₃Cl₅: Dy, and SrCl₂: Dy. The method of doping Dy into these crystals are well know for those skilled in the art. In the case of polymers, the rare-earth polymers that we disclosed earlier are the preferred polymers.

The simple three-state model may describe the three and four state amplifiers according to the present invention. The rare earth ions start out in their ground state. The electrons are then excited by a pump beam of photons with energy hνₚ (h is planks constant and νₚ is the frequency of the photon) equal to the equal to the transition energy from the ground state, level one, to an excited state, level two. The ions subsequently undergo fast nonradiative decay to another excited state, level three, which is the metastable state of the system. The lifetime of this state is very long in comparison to the nonradiative decay. As a consequence, a population inversion is created in level three. Then, as a signal beam passes by the ions, it stimulates emission of photons with the same signal energy, hνₛ. This stimulated decay is from level three to level one, the ground state.

The pump photons enter the Dy, Pr, or Nd doped fiber or waveguide core are absorbed by the ground state Dy, Pr, or Nd ions. The absorption of the pump photons causes the excitation of the ions into their excited energy state. The excited state ions rapidly (in less than about 1 μsec) relax to the metastable excited state. The metastable excited state has a relatively long lifetime when not triggered (greater than about 5 μsec). When triggered by a signal photon with wavelength around 1.31 μm, a metastable state ion drops back to its ground state and releases a emission photon identical to the triggering signal photon, thereby amplifying the signal.

For example, light amplification from Pr doped materials results when an electron of about 0.98 μm is exiting from the ground-state ³H₄ ion to an excited state. The electrons subsequently undergo fast nonradiative decay to ¹G₄. The electron relaxing from the ¹G₄ level to the ³H₅ level, gives its energy up as a photon. The photon interacts with an electron in an excited energy level resulting in the formation of an additional photon with same wavelength and phase. ESA in FIG. 9 is defined as the excited-state absorption.

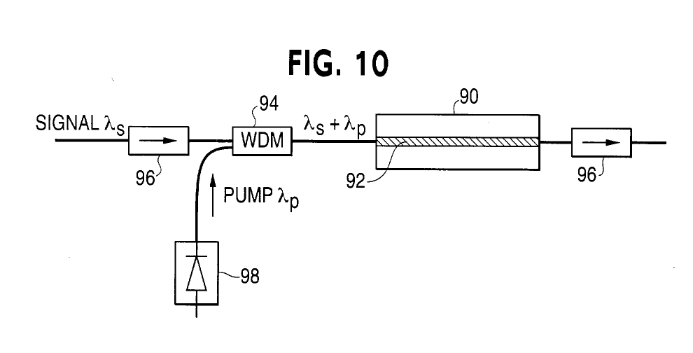

FIG. 10 is a schematic illustration of the configuration of a 1.3 μm waveguide amplifier comprising isolators 96, wavelength division multiplexer 94 (WDM), and doped nano-composite channel waveguide 90. The signal λ_{S} is coupled with pump signal λ_{P} (λ_{P} generated by pump source 98) through WDM 94 and injected into the amplification waveguide channel 92. Optical signals isolators 96 are placed at the input and the output end of the waveguide amplifier to prevent back reflected signal light.

The pump wavelength for Dy doped nano-composite waveguide amplifier are 1.11 μm, 0.92 μm, and 0.81 μm. The pump wavelength for Pr doped nano-composite waveguide amplifier are 0.97 μm, 0.98 μm, and 1.01 μm. The pump wavelength for a Nd doped nano-composite waveguide amplifier is approximately 0.8 μm.

What is claimed is:

1. An optical waveguide amplifier comprising:
a composite material comprising,
a host matrix,
a plurality of nanoparticles within the host matrix;
said plurality of nanoparticles further comprising at least one Dysprosium Praseodymium, and Neodymium containing material.

2. The amplifier of claim 1, wherein said at least one material is an ion, oxide, compound, or complex of Dy³⁺, Pr³⁺, and Nd³⁺.

3. The amplifier of claim 1, wherein said at least one material is Dy³⁺.

4. The amplifier of claim 1, wherein said at least one material is Pr³⁺.

5. The amplifier of claim 1, wherein said host matrix is a polymer, a solvent, a liquid crystal, or a crystal.

6. The amplifier of claim 5, wherein said host matrix is a halogen containing polymer.

7. The amplifier of claim 5, wherein said host matrix comprises a polymer, a copolymer, or a terpolymer having at least one halogenated monomer chosen from one of the following formulas: 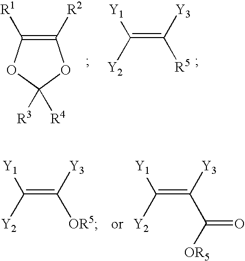
wherein,
R¹, R², R³, R⁴, and R⁵, which may be identical or different, are each chosen from linear or branched hydrocarbon-based chains, capable of forming at least one carbon-based ring, being saturated or unsaturated, wherein at least one hydrogen atom of the hydrocarbon-based chains may be halogenated; a halogenated alkyl, a halogenated aryl, a halogenated cyclic alky, a halogenated alkenyl, a halogenated alkylene ether, a halogenated siloxane, a halogenated ether, a halogenated polyether, a halogenated thioether, a halogenated silylene, and a halogenated silazane;
Y₁ and Y₂, which may be identical or different, are chosen from H, F, Cl, and Br atoms; and
Y₃ is chosen from H, F, Cl, and Br atoms, CF₃, and CH₃.

8. The amplifier claim 7, wherein R¹, R², R³, R⁴, and R⁵ are at least partially fluorinated.

9. The amplifier of claim 7, wherein R¹, R², R³, R⁴, and R⁵ are completely fluorinated.

10. The amplifier of claim 7, wherein at least one of R¹, R², R³, R⁴, and R⁵ is chosen from C₁-C₁₀, linear or branched, saturated or unsaturated hydrocarbon-based chains.

11. The amplifier of claim 6, wherein said host matrix comprises a polymer condensation product of at least one of the following monomeric reactions:
HO—R—OH+NCO—R′—NCO; or
HO—R—OH+Ary¹-Ary²,
wherein
R, R′, which may be identical or different, are chosen from one of halogenated alkylenes, halogenated siloxanes, halogenated ethers, halogenated silylenes, halogenated arylenes, halogenated polyethers, and halogenated cyclic alkylenes; and
Ary¹, Ary², which may be identical or different, are chosen from halogenated aryls and halogenated alkyl aryls.

12. The amplifier of claim 6, wherein said host matrix comprises a material chosen from halogenated polycarbonates, halogenated cyclic olefin polymers, halogenated cyclic olefin copolymers, halogenated polycyclic polymers, halogenated polyimides, halogenated polyether ether ketones, halogenated epoxy resins, and halogenated polysulfones.

13. The amplifier of claim 6, wherein said host matrix comprises a combination of two or more different fluoropolymer materials.

14. The amplifier of claim 6, wherein said host matrix further comprises halogenated polymers having functional groups chosen from phosphinates, phosphates, carboxylates, silanes, siloxanes, and sulfides.

15. The amplifier of claim 12, wherein said material comprises functional groups chosen from POOH, POSH, PSSH, OH, SO₃H, SO₃R, SO₄R, COOH, NH₂, NHR, NR₂, CONH₂, and NH—NH₂, wherein R denotes:
linear or branched hydrocarbon-based chains, capable of forming at least one carbon-based ring, being saturated or unsaturated;
alkylenes, siloxanes, silanes, ethers, polyethers, thioethers, silylenes, and silazanes.

16. The amplifier of claim 1, wherein at least one material comprising said host matrix is chosen from homopolymers, or copolymers, of vinyl, acrylate, methacrylate, vinyl aromatic, vinyl ester, alpha beta unsaturated acid ester, unsaturated carboxylic acid ester, vinyl chloride, vinylidene chloride, and diene monomers.

17. The amplifier of claim 6, wherein said host matrix comprises a hydrogen-containing fluoroelastomer.

18. The amplifier of claim 6, wherein said host matrix further comprises a cross-linked halogenated polymer.

19. The amplifier of claim 18, wherein said halogenated polymer comprises a fluorinated polymer.

20. The amplifier of claim 6, wherein said host matrix comprises a perhalogenated polymer.

21. The amplifier of claim 20, wherein the perhalogenated polymer comprises a perfluorinated polymer.

22. The amplifier of claim 6, wherein said host matrix comprises a hydrogen-containing perfluoroelastomer.

23. The amplifier of claim 6, wherein said host matrix comprises a hydrogen-containing fluoroplastic.

24. The amplifier of claim 6, wherein said host matrix comprises a hydrogen-containing perfluorothermoplastic.

25. The amplifier of claim 6, wherein said host matrix comprises a blend of halogenated polymers.

26. The amplifier of claim 25, wherein said blend comprises fluorinated, and perfluorinated polymers.

27. The amplifier of claim 6, wherein said host matrix comprises poly[2,2-bistrifluoromethyl-4,5-difluoro-1,3-dioxole-co-tetrafluoroethylene].

28. The amplifier of claim 6, wherein said host matrix comprises poly[2,2-bisperfluoroalkyl-4,5-difluoro-1,3-dioxole-co-tetrafluoroethylene].

29. The amplifier of claim 6, wherein said host matrix comprises poly[2,3-(perfluoroalkenyl) perfluorotetrahydrofuran].

30. The amplifier of claim 6, wherein said host matrix comprises poly[2,2,4-trifluoro-5-trifluoromethoxy-1,3-dioxole-co-tetrafluoroethylene].

31. The amplifier of claim 6, wherein said host matrix comprises poly(pentafluorostyrene).

32. The amplifier of claim 6, wherein said host matrix comprises fluorinated polyimide.

33. The amplifier of claim 6, wherein said host matrix comprises fluorinated polymethylmethacrylate.

34. The amplifier of claim 6, wherein said host matrix comprises polyfluoroacrylates.

35. The amplifier of claim 6, wherein said host matrix comprises polyfluorostyrene.

36. The amplifier of claim 6, wherein said host matrix comprises fluorinated polycarbonates.

37. The amplifier of claim 6, wherein said host matrix comprises perfluoro-polycyclic polymers.

38. The amplifier of claim 6, wherein said host matrix comprises fluorinated cyclic olefin polymers.

39. The amplifier of claim 6, wherein said host matrix comprises fluorinated copolymers of cyclic olefins.

40. The amplifier of claim 6, wherein said plurality of nanoparticles further comprises at least one ion, oxide, compound, or complex, of an element chosen from rare-earth metals, transition metals, precious metal, groups II, IV or V elements, V³⁺, Cr³⁺, Cr⁴⁺, Co²⁺, Fe²⁺, Ni²⁺, Ti³⁺, and Bi³⁺.

41. The amplifier of claim 40, wherein said element is combined with at least one material chosen from oxides, phosphates, halophosphates, arsenates, sulfates, borates, aluminates, gallates, silicates, germanates, vanadates, niobates, tantalates, tungstates, molybdates, alkalihalogenates, halides, nitrides, nitrates, sulfides, zirconates, selenides, sulfoselenides, oxysulfides, phosphinates, hexafluorophosphinates, and tetrafluoroborates.

42. The amplifier of claim 40, wherein said at least one compound is a semiconductor compound.

43. The amplifier of claim 42, wherein said semiconductor compound is chosen from Si, PbS, Ge, GaP, GaAs, InP, InAs, InSb, PbSe, and PbTe.

44. The amplifier of claim 40, wherein said groups III, IV, or V compounds are n-type.

45. The amplifier of claim 1, wherein said plurality of nanoparticles comprises at least one material having an index of refraction ranging from about 1 to about 5.

46. The amplifier of claim 45, wherein said plurality of nanoparticles comprises at least one material having an index of refraction ranging from about 1.5 to about 4.5.

47. The amplifier of claim 40, wherein said plurality of nanoparticles further comprises at least one material chosen from lithium niobate, non-linear optical chromophores, and organic dyes.

48. The amplifier of claim 1, wherein said plurality of nanoparticles further comprises at least one material chosen from dye materials.

49. The amplifier of claim 1, wherein said plurality of nanoparticles further comprises at least one functional group chosen from POOH, POSH, PSSH, OH, SO₃H, SO₃R, SO₄R, COOH, NH₂, NHR, NR₂, CONH₂, and NH—NH₂, wherein R is chosen from linear or branched hydrocarbon-based chains, capable of forming at least one carbon-based ring, being saturated or unsaturated, alkylenes, siloxanes, silanes, ethers, polyethers, thioethers, silylenes, and silazanes.

50. The amplifier of claim 1, wherein said plurality of nanoparticles comprises at least one polymer nanocomposite.

51. The amplifier of claim 50, wherein said at least one polymer is chosen from homopolymers, or copolymers, of vinyl, acrylic, vinyl aromatic, vinyl esters, alpha beta unsaturated acid esters, unsaturated carboxylic acid esters, vinyl chloride, vinylidene chloride, and diene monomers.

52. The amplifier of claim 1, wherein a majority of said plurality of nanoparticles has a major dimension of less than about 50 nm.

53. The amplifier of claim 1, wherein a majority of said nanoparticles are coated.

54. The amplifier of claim 53, wherein said nanoparticles include a halogenated outer coating layer comprising at least one halogen chosen from fluorine, chlorine, and bromine atoms.

55. The amplifier of claim 54, wherein the halogenated outer coating layer is formed from at least one halogenated material chosen from polyphosphates, phosphates, phosphinates, dithiophosphinates, pyrophosphates, alkyl titanates, alkyl zirconates, silanes, alcohols, amines, carboxylates, amides, sulfates, esters, acid chloride, acetylacetonate, thiols, and alkylcyanide.

56. The amplifier of claim 55, wherein the halogenated outer coating layer is fluorinated.

57. The amplifier of claim 54, wherein said plurality of nanoparticles further includes an inner coating disposed beneath the halogenated outer coating layer, wherein the inner coating includes one or more passivation layers.

58. The amplifier of claim 57, wherein the halogenated outer coating layer comprises a material that reacts with and neutralizes a radical group on at least one of the plurality of nanoparticles.

59. The amplifier of claim 58, wherein the radical group is OH.

60. The amplifier of claim 58, wherein the radical group comprises an ester.

61. An optical waveguide amplifier comprising:
a composite material comprising,
a halogen containing host matrix, and
a plurality of nanoparticles within the host matrix; and
wherein said plurality of nanoparticles comprise at least one dopant material that provides amplification at approximately 1.3 μm.

62. The amplifier of claim 61, wherein said at least one dopant material is chosen from Dysprosium, Praseodymium, and Neodymium.

63. The amplifier of claim 62, wherein said at least one dopant material is Dy³⁺.

64. The amplifier of claim 62, wherein said at least one dopant material is Pr³⁺.

65. The optical waveguide of claim 61, wherein said dopant material is capable of producing stimulated emissions of light at a wavelength about 1.3 μm when pumped with the light of wavelength about 0.97 μm, said waveguide having input and output end.

66. An optical amplifying waveguide including a core, said core comprising
a composite material comprising,
a host matrix; and
a plurality of nanoparticles dispersed within the host matrix, wherein a majority of the plurality of nanoparticles include a halogenated outer coating layer,
wherein said nanoparticles comprise at least one dopant material chosen from Dysprosium, Praseodymium, and Neodymium; and
a core-cladding comprised of a lower refractive index material, such that a core-cladding refractive index difference is small enough to result in a single optical mode propagation for optical wavelengths ranging from 1.27 μm to about 1.6 μm.

67. An apparatus for optical communication including:
an active material comprising,
a halogen containing host matrix, and
a plurality of nanoparticles within the host matrix, wherein said plurality of nanoparticles comprise at least one material chosen from Dysprosium, Praseodymium, and Neodymium,
generating an optical signal and an optical pumping,
providing said optical signal and said optical pumping to said waveguide; and
controlling light emitted from said optical waveguide.

68. The apparatus according to claim 67, wherein said apparatus is an optical amplification system for use in a second loss window.

69. An optical amplifier for wavelength ranging from about 1.27 μm to about 1.6 μm comprising:
nanoparticle composite material comprising:
a host matrix
a plurality of nanoparticles dispersed within the host matrix, wherein a majority of nanoparticles includes a halogenated outer coating layer, and
a majority of nanoparticles includes at least one material chosen from Dysprosium, Praseodymium, and Neodymium.

70. A method for amplifying a light signal, said method comprising,
forming a component from a composite material comprising, a halogen containing host matrix, and a plurality of nanoparticles within the host matrix; and doping said host matrix with nanoparticles comprising at least one material chosen from Dysprosium, Praseodymium, and Neodymium, exciting ions of said at least one material into their excited energy state, and emitting a photon substantially identical to the triggering signal photon.

71. A method for amplifying a light signal, said method comprising forming a component from a composite material comprising, a halogen containing host matrix, and a plurality of nanoparticles within the halogen containing host matrix; and doping said halogen containing host matrix with nanoparticles comprising at least one material chosen from materials capable of producing stimulated emissions of light within a wavelength ranging from about 1.27 μm to about 1.34 μm.

72. The apparatus according to claim 71, wherein said apparatus is and an optical amplifier comprising: a low phonon energy optical medium,
and a device for pumping the low phonon energy optical medium to obtain an amplified optical signal within said wavelength range of about 1.27 μm to about 1.34 μm.
